(19) United States
(12) Patent Application Publication
(10) Pub. No.: US 2017/0291141 A1
(43) Pub. Date: Oct. 12, 2017

(54) PORTABLE WATER COLLECTION AND FILTRATION SYSTEM

(71) Applicant: My Aqueduct, LLC, Southfield, MI (US)

(72) Inventors: Marvin E. Dunham, Berlin, MD (US); Arik Brown, Woodstock, MD (US); Homer Sparks, Nashville, TN (US)

(73) Assignee: My Aqueduct, LLC, Southfield, MI (US)

(21) Appl. No.: 15/482,528

(22) Filed: Apr. 7, 2017

Related U.S. Application Data
(60) Provisional application No. 62/319,511, filed on Apr. 7, 2016.

(51) Int. Cl. B01D 61/02; B01D 61/14

(52) U.S. Cl. CPC B01D 61/025; B01D 61/147; C02F 1/441

(57) ABSTRACT

A portable water collection, filtration and power generation system is provided. The system is comprised of a holding tank, a filtration system, a reverse osmosis system an electrical power generator a mobile transport unit that holds the holding tank, filtration system, reverse osmosis system, and the electrical power generator. The holding tank is configured to receive water from a water source. The filtration system is fluidly coupled to the holding tank and includes an input configured to receive water from the holding tank, a filter disposed in fluid communication with the input, and an output to configured to discharge filtered water from the filtration system. The reverse osmosis system is fluidly coupled to the filtration system. The reverse osmosis system includes an input configured to receive filtered water from the filtration system and an output to configured to discharge reverse osmosis water. At least one electrical power generator is electrically coupled either the filtration system or the reverse osmosis system.

### CROSS-REFERENCE TO RELATED APPLICATIONS

This application claims priority from, and incorporates the disclosure of U.S. Provisional Patent Application No. 62/319,511, filed Apr. 7, 2016.

### BACKGROUND

While safe drinking water is a universal requirement for adequate health, millions of people worldwide, particularly those in third world countries, lack an adequate supply of clean drinking water. In many developing and third world countries, population increases have combined with inadequate sewage treatment facilities to render the water of the aquifers or underground wells in those countries unfit for human consumption. As a result, the available drinking water can be contaminated with bacteria, viruses, and other parasites that can cause potentially fatal diseases, thus profoundly affecting the health of the population. Safe drinking water is also an important requirement for persons affected by natural disasters and military personnel engaged in armed conflicts.

Most households and businesses that receive water from a municipal water supply or other public waterworks depend totally on the filtration system provided by the municipality for ensuring the purity of the water. There are shortcomings, however, in the filtration and purification systems used by many public waterworks. Many arise from the large water volume and the wide, complex distribution network that public waterworks must have to supply the water needs of users ranging into the millions. Another shortcoming inherent in public waterworks is that all of the water is filtered the same for all users.

A substantially untapped source of clean drinking water is precipitation, including rainwater, snow, and sleet.

### SUMMARY OF THE INVENTION

A portable water collection, filtration and power generation system is provided. The system is comprised of a holding tank, a filtration system, a reverse osmosis system an electrical power generator a mobile transport unit that holds the holding tank, filtration system, reverse osmosis system, and the electrical power generator. The holding tank is configured to receive water from a water source. The filtration system is fluidly coupled to the holding tank and includes an input configured to receive water from the holding tank, a filter disposed in fluid communication with the input, and an output configured to discharge filtered water from the filtration system. The reverse osmosis system is fluidly coupled to the filtration system. The reverse osmosis system includes an input configured to receive filtered water from the filtration system and an output configured to discharge reverse osmosis water. At least one electrical power generator is electrically coupled either the filtration system or the reverse osmosis system.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of an example precipitation collection and filtration system.

FIG. 2 is an isometric view of an example mobile transport unit.

FIG. 3 is a schematic circuit diagram of a control system that may be incorporated into the system of FIG. 1 to operate and regulate the system.

### DETAILED DESCRIPTION

The present disclosure is related to providing water filtration and energy generation and, more particularly, to a portable water collecting and filtration system that incorporates electrical power generation.

The portable water collecting and purifying system described herein is designed to collect various sources of water, and filter and disinfect the collected water such that the treated water is suitable for human consumption. In some cases, the water collected can include various forms of precipitation, such as rain, snow, or sleet. The system is self-contained and, therefore, can be transported to various locations where needed. For example, the currently described system may be especially advantageous for use in underdeveloped, remote, or rural areas, but may also be used in areas affected by drought or disaster or other locations having a limited supply of clean drinking water. The portable water collecting and purifying system described herein may also be configured to generate electrical power that may be used to power various component parts of the system or alternatively be provided back into the electrical grid. Accordingly, the system may be useful in taking precipitation and other sources water and convert them into fresh drinking water and energy, and may be able to do so on a magnitude that meets residential, retail, commercial, or light industrial applications.

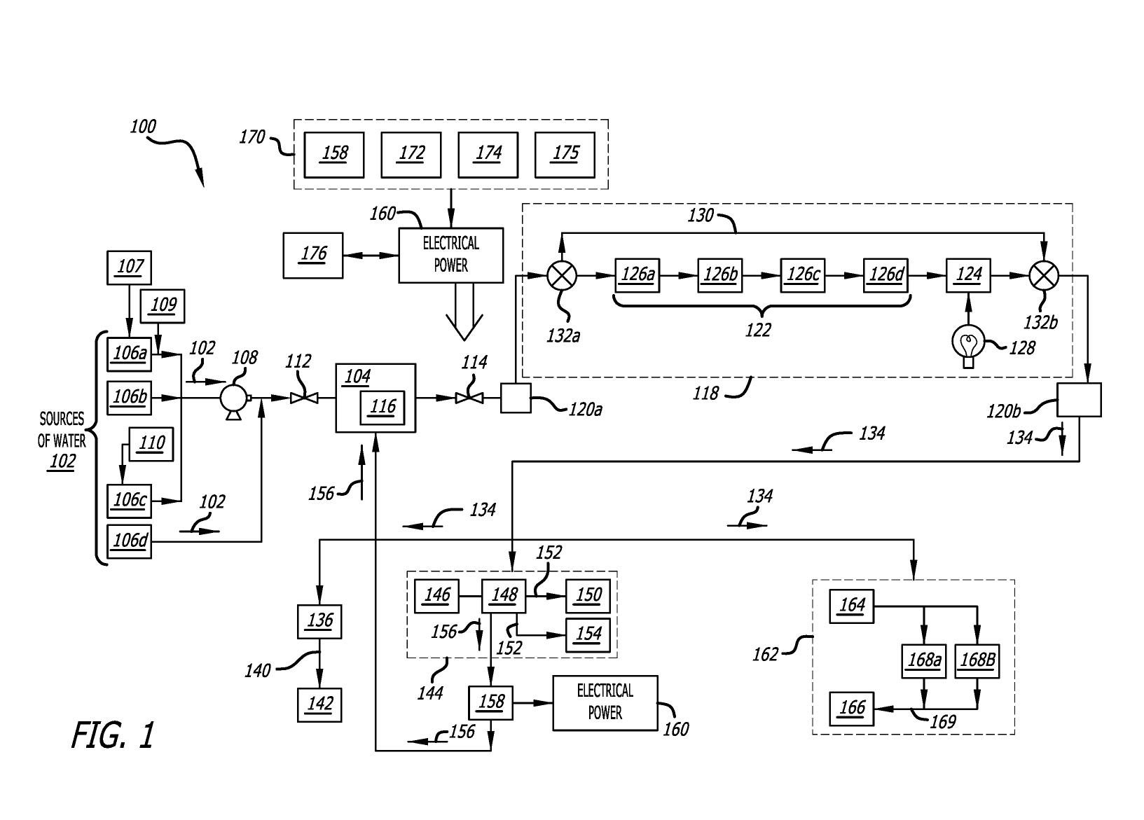

FIG. 1 is a schematic diagram of an example water collection and filtration system 100, according to one or more embodiments. In some embodiments, the water collection and filtration system 100 (hereafter “the system 100”) may be permanently installed at a desired location, such as at a residence, a commercial building, or a retail building. In other embodiments, however, some or all of the component parts of the system 100 may be secured to and otherwise carried by a mobile transport unit, as will be described below. Accordingly, the system 100 may be characterized as being mobile and otherwise able to be transported to locations where needed.

The system 100 is able to obtain or “collect” water 102 from one or more sources 106 (four shown as sources 106a, 106b, 106c, and 106d) and provide (convey) the collected water 102 to a holding tank 104. The sources 106a-d of water 102 can include, but are not limited to, precipitation 106a, groundwater 106b, dehumidifier water 106c, and a municipal water source 106d.

The collected water 102 may be transferred to the holding tank 104 using hoses, piping, conduits, connections, fittings, valving, etc. that are compliant with U.S. Food and Drug Administration (FDA) and Environmental Protection Agency (EPA) safety regulations. Indeed, all of the hoses, piping, conduits, connections, fittings, valving, etc. used in the system 100 may be compliant with current FDA and/or EPA safety regulations. In at least one embodiment, for instance, some or all of the hoses, piping, or conduits used in the system 100 may comprise premium drinking water safe garden hoses commercially available from local hardware stores. In other embodiments, some or all of the hoses, piping, or conduits used in the system 100 may comprise a braided stainless steel flex line commonly used in commercial or residential filter systems. In yet other embodiments, some or all of the hoses, piping, or conduits used in the system 100 may comprise clear PVC tubing, without departing from the scope of the disclosure.

A pump 108 may be included in the system 100 and used to convey at least one of the precipitation 106a, the groundwater 106b, and the dehumidifier water 106c to the holding tank 104. The pump 108 may comprise, for example, a 130 gallon per hour (GPH) pool cover pump, available from BECKETT™ of Irving, Tex., USA, but could alternatively comprise another type of pump. The pump 108 may prove advantageous in providing pressurized water to the holding tank 104. In other embodiments, however, the pump 108 may be omitted from the system 100, and one or all of the precipitation 106a, the groundwater 106b, and the dehumidifier water 106c may alternatively be fed to the holding tank 104 under gravitational forces. In some embodiments, the holding tank 104 may be maintained at or near atmospheric pressure. In other embodiments, however, as discussed below, the holding tank 104 may be pressurized through the use of one or more pressure relief valves or overflow valves.

The precipitation 106a includes rainwater, snow, sleet, etc., and may be collected via various means. The precipitation 106a may be collected through various means or collection devices 107. One example collection device 107 comprises a gutter and downspout assembly of residential and/or commercial buildings and fed into a collection hopper or the like to be pumped to the holding tank 104 with the pump 108. Another example collection device 107 may comprise a tarp or other collection substrate spread across a large surface area and used to catch or capture precipitation falling from the atmosphere. A hole may be provided at the center (or another location) of the tarp to funnel the captured precipitation into the collection hopper to be pumped to the holding tank 104 with the pump 108. Yet another example collection device 107 may comprise a catch basin or other rigid receptacle that may be situated to catch or capture precipitation falling from the atmosphere. The catch basin may be a permanent or temporary structure and, in some embodiments, may serve as a storage point for the precipitation 106a prior to being processed by the system 100.

In some embodiments, the system 100 may also include a heater 109 used to warm the precipitation 106a when needed. The heater 109 may prove especially advantageous in warming sleet or snow so that by liquefies and is thereby able to be pumped with the pump 108. In at least one embodiment, the heater 109 may include a vent tube, such as an insulated heating, ventilation, and air conditioning (HVAC) tube. In such embodiments, the vent tube may be directed at the sleet or snow to melt the sleet or snow into liquid water.

The groundwater 106b may include, for example, water obtained from a natural body of water, such as a river, a lake, a stream, etc.

The dehumidifier water 106c may be obtained from a conventional dehumidifier 110 included in the system 100. The dehumidifier 110 operates to remove water out of the atmosphere. With 30% or more humidity in the ambient atmosphere, the dehumidifier 110 may be able to collect an average of about 8 gallons of water per day. In some embodiments, more than one dehumidifier 110 may be used in parallel in the system 100 and thereby increase the volume of collectable dehumidifier water 106c.

The municipal water source 106d may be an option for the system 100 and will depend on the geographical location of the system 100 and the availability to tap into the local water sources. Including the municipal water source 106d in the system 100 may prove advantageous in being able to provide the system 100 with a constant source of water 102 at a known hydraulic pressure.

A float valve 112 may be included with the holding tank 104 and configured to regulate the flow of the water 102 into the holding tank 104 and ensure that the holding tank 104 does not overflow. Accordingly, the float valve 112 may be operate to maintain the water 102 level in the holding tank 104 at or below a predetermined volume or level and stop flow of the water 102 upon surpassing the predetermined volume or level.

As mentioned above, the holding tank 104 may be maintained at atmospheric pressure in some applications. In other embodiments, however, the system 100 may further include a pressure relief valve 114 used to maintain the holding tank 104 at an elevated pressure and regulate (meter) the flow of the water 102 out of the holding tank 104 at a known pressure. In some embodiments, the system 100 may be configured for operation between about 20 psi and about 90 psi. The average pressure for the system 100 may be approximately 55-65 psi. The flow rate of the system 100 will depend on the size of the installation piping and the configuration of the pressure relief valve 114. In at least one embodiment, the system 100 may be designed to achieve a minimum flow rate of 400-800 gallons per day.

In some embodiments, the holding tank 104 may include a submersible pump 116 used to pump the collected water 102 out of the holding tank 104 and into an adjacent filtration system 118. The pressure relief valve 114 regulates the flow of the water 102 into the filtration system 118, which receives the unfiltered water 102 from the holding tank 104 at an inlet 120a. The filtration system 118 may be configured to filter the water 102 to remove harmful contaminants and contagions, and provide filtered water 134 at an outlet 120b. As illustrated, the filtration system 118 may include several filtration components, including one or more filters 122 (four shown) and an ultraviolet (UV) light sterilizer 124. In some embodiments, the filtration system 118 may be commercially available from AQUASANA® of Austin, Tex., USA.

The filters 122 may include a pre-filter 126a, one or more medium filters (two shown as filters 122b and 122c), and a post-filter 126d. While four filters 126a-d are shown in FIG. 1, it will be appreciated that more or less than four filters 126a-d may be employed, without departing from the scope of the disclosure.

The pre-filter 126a may be used to catch (filter out) rust, sediment, silt, and other particulates that may be suspended in the incoming water 102. The medium filter(s) 126b,c may be configured to remove bacteria, chlorides, algae, chemicals, pharmaceuticals, and heavy metals (particulates of ionized heavy metals) from the water 102. To accomplish this, one or both of the medium filter(s) 126b,c may comprise activated carbon filters or KDF-55 or 85 filters. In at least one embodiment, one of the medium filters 126b,c may comprise a water softener that prevents minerals from binding and forming scale build-up. The post-filter 126d may be configured to reduce any remaining sediment and organic particles down to about 0.35 microns or less.

The UV light sterilizer 124 may receive the water 102 from the post-filter 126d and may be used to eliminate bacteria, viruses, and pathogens that might be present in the water 102. The UV light sterilizer 124 includes a UV light source 128.

The filtration system 118 may also include a bypass fluid circuit 130 that includes a first tee valve 132a and a second tee valve 132b. The first tee valve 132a is located downstream from the inlet 120a, but upstream from the filters 122. The second tee valve 132b is located upstream from the outlet 120b, but downstream from the UV light sterilizer 124. The first and second tee valves 132a,b may be actuated (moved) to divert the flow of the water 102 into the bypass circuit 130 and otherwise around the filters 122 and the ultraviolet UV light sterilizer 124. While the water 102 flows through the bypass circuit 130, the filters 122 and/or the ultraviolet UV light sterilizer 124 may be repaired or replaced. Accordingly, the bypass circuit 130 may be able to provide the water 102 directly to the outlet 120b without filtration. In normal operation, the water 102 is conveyed through the filters 122 and the ultraviolet UV light sterilizer 124 to provide the filtered water 134 at the outlet 120b.

From the outlet 120b of the filtration system 118, the filtered water 134 may be conveyed to various additional components of the system 100 or alternatively to a separate location. In one embodiment, for example, the filtered water 134 may be conveyed to a water distillation system 136 included in the system 100. The water distillation system 136 may be configured to distill the filtered water 134 and thereby produce distilled water 140. In some embodiments, the water distillation system 136 may be capable of generating eight gallons of distilled water 150 per day, with a six-gallon reserve tank. The water distillation system 136 may also include or otherwise be fluidly coupled to a point of consumption 142. The point of consumption 142 may comprise, for example, a faucet, a spigot, or another type of valving mechanism that allows a user to access the distilled water 140 for consumption or for other uses.

In other embodiments, the filtered water 134 may be conveyed under pressure to a reverse osmosis system 144 that may also be included in the system 100. The reverse osmosis system 144 may include various component parts and mechanisms configured to provide reverse osmosis filtration to the filtered water 134. For example, the reverse osmosis system 144 may include a permeate pump 146, a reverse osmosis filter 148, and a storage tank 150. The filtered water 134 enters the reverse osmosis system 144 and the permeate pump 146 works to maintain a pressure differential across a reverse osmosis membrane as the filtered water 134 circulates through the reverse osmosis filter 148.

The reverse osmosis system 144 may be capable of generating between about fourteen gallons and twenty gallons of reverse osmosis water 152 per day. In some embodiments, the reverse osmosis water 152 may be provided to the storage tank 150 for later consumption or other use. The storage tank 150 may hold up to fourteen gallons of the reverse osmosis water 152. Alternatively, or in addition thereto, the reverse osmosis water 152 may be conveyed to a point of consumption 154, such as a faucet, a spigot, or another type of valving mechanism that allows a user to access the reverse osmosis water 152 for consumption or for other uses.

The reverse osmosis system 144 may also be configured to produce a stream of wastewater 156. The wastewater 156 contains higher levels of byproducts and contaminants removed through the reverse osmosis process and not captured by the reverse osmosis membrane. However, the level of byproducts and contaminants in the wastewater 156 is less than the amounts contained in the water 102 initially introduced into the system 100 at the holding tank 104 and prior to the filtration system 118. In some embodiments, all or a portion of the wastewater 156 may be conveyed back to the holding tank 104 so that it can be processed in the filtration system 118. As will be appreciated, recycling the wastewater 156 may prove advantageous in increasing the efficiency and performance of the reverse osmosis system 144 by reducing the amount of water required and eliminating wasted water while the reverse osmosis system 144 is utilized.

In at least one embodiment, all or a portion of the wastewater 156 may be conveyed to a hydroelectric generator 158 to convert the hydraulic pressure of the wastewater 156 into electrical power 160. The hydroelectric generator 158 may include a turbine, for example, that converts the fluid pressure of the wastewater 156 into rotational motion, which can generate the electrical power 160. As discussed below, some or all of the electrical power 160 may be used to power or help power various components of the system 100, but may alternatively be returned back to the grid. Accordingly, at least a portion of the energy initially provided to the system 100 by the pump 108 or the hydraulic pressure of the municipal water source 106d may be recouped through use of the hydro-electric generator 158.

It should be noted that, while the hydro-electric generator 158 is shown in the system 100 as being located downstream from the reverse osmosis system 144, it will be appreciated that the hydro-electric generator 158 may be arranged at a variety of locations in the system 100, without departing from the scope of the disclosure. Indeed, the hydro-electric generator 158 may be located at any point in the system 100 downstream from the pump 108 or the municipal water source 106d to enable the hydraulic pressure provided by the pump 108 or the municipal water source 106d to power portions of the system 100.

In yet other embodiments, the filtered water 134 may be conveyed to a building 162 for storage or consumption. For instance, the outlet 120b of the filtration system 118 may be fluidly coupled a property water line for the building 162, which can include a residence, a commercial building, or a retail establishment. In some embodiments, the filtered water 134 may be conveyed to a storage tank 164 located at the building 162 and subsequently conveyed to a point of consumption 166 when needed. Similar to the points of consumption 142, 154 discussed above, the point of consumption 166 may comprise a faucet, a spigot, or another type of valving mechanism that allows a user to access the filtered water 134 from the storage tank 164 for consumption or for other uses. In at least one embodiment, the point of consumption 166 may comprise a water cooler or the like.

In some embodiments, the filtered water 134 may be conveyed to one or both of a tankless water heater 168a and a solar water heater 168b included at the building 162. One or both of the tankless or solar water heaters 168a,b may either receive the filtered water 134 directly from the outlet 120b to the filtration system 118, or may instead receive the filtered water 134 from the storage tank 164. The tankless water heater 168 may be configured to condition (e.g., heat or cool) the filtered water and thereby provide conditioned water 169 to the point of consumption 166.

The system 100 may further include one or more electrical power generators 170. In some embodiments, the electrical power generators 170 may be configured to provide electrical power 160 to various electricity-consuming components of the system 100, such as the pump 108, the heater 109, dehumidifier 110, the submersible pump 116, the UV light sterilizer 124, the water distillation system 136, the tankless water heater 168, or other electricity-consuming components of the system 100. Accordingly, the electrical power generators 170 may be wired or wirelessly coupled to some or all of the electricity-consuming components of the system 100. In other embodiments, all or a portion of the electrical power 160 generated by the electrical power generators 170 may be returned back to the grid.

As illustrated, the electrical power generators 170 may include the hydroelectric generator 158 described above, a wind power generator 172, a solar power generator 174, and a nanogenerator (e.g., a piezoelectric generator) 175. The wind power generator 172 may comprise a portable wind turbine used to convert wind power into the electrical power 160. The solar power generator 174 may comprise one or more solar generator kits with flexible or rigid solar panels. In some embodiments, the solar generator kit may include a 1250 kW battery for storing the captured solar energy. The nanogenerator 175 may be configured to convert mechanical vibrations into electricity.

An AC/DC converter or inverter 176 may be included in the system 100 and used to convert the electrical power 160 to a form suitable for consumption by the electricity-consuming components of the system 100.

In some embodiments, the system 100 can include an energy storage device. In such an embodiment, the energy storage device can be coupled to at least one of the electrical power generators in the system 100. It is contemplated that energy storage device can be a capacitor, a battery or any other storage device capable of storing energy.

In some embodiments, the system 100 may be placed in series or in parallel with another system 100. The system 100 may be placed in parallel with another system 100 if the water and energy demand is higher, and thereby increase the capacity of the system(s) 100. Alternatively, the system 100 may be placed in series with another system 100 to increase the filtration capabilities. This may prove advantageous if the water 102 collected from the sources 106a-d is highly contaminated. In embodiments where multiple systems 100 are placed in series, the combined systems 100 may further include manual or automated monitoring and testing to detect baseline analysis and key attribute metrics for contaminants and operational parameters.

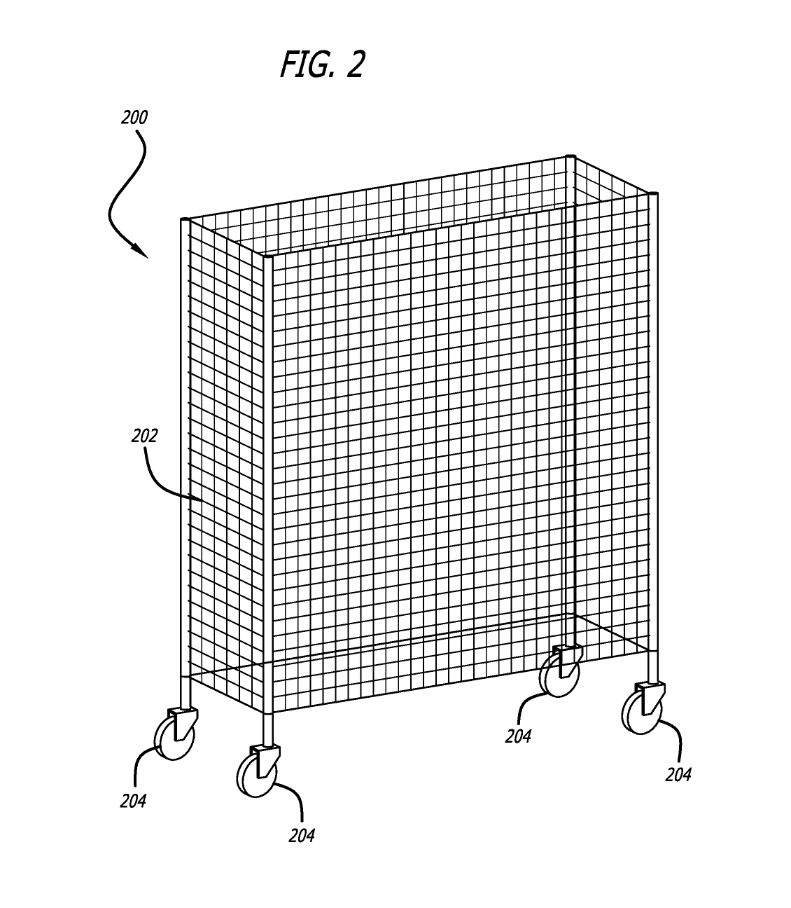

FIG. 2 is an isometric view of an example mobile transport unit 200, according to one or more embodiments. The mobile transport unit 200 may be configured to house, store, and transport the system 100, including some or all of the component parts described above with reference to FIG. 1. As illustrated, the mobile transport unit 200 may comprise a generally rectangular body 202 made of a plurality of welded metal wires. It will be appreciated, however, that the body 202 may comprise other polygonal shapes or may alternatively include rounded shapes (e.g., circular, cylindrical, ovoid, etc.) without departing from the scope of the disclosure. Moreover, the body 202 may be made of any rigid material, without departing from the scope of the disclosure. In some embodiments, the flexible solar panels of the solar power generator 174 (FIG. 1) may be mounted on and otherwise wrapped about the sidewalls of the body 202.

The mobile transport unit 200 may also include a plurality of casters or wheels 204 (four shown) used to facilitate movement for the mobile transport unit 200. While not shown, the mobile transport unit 200 may further include one or more shelves or storage compartments used to support and/or house some or all of the component parts of the system 100 of FIG. 1.

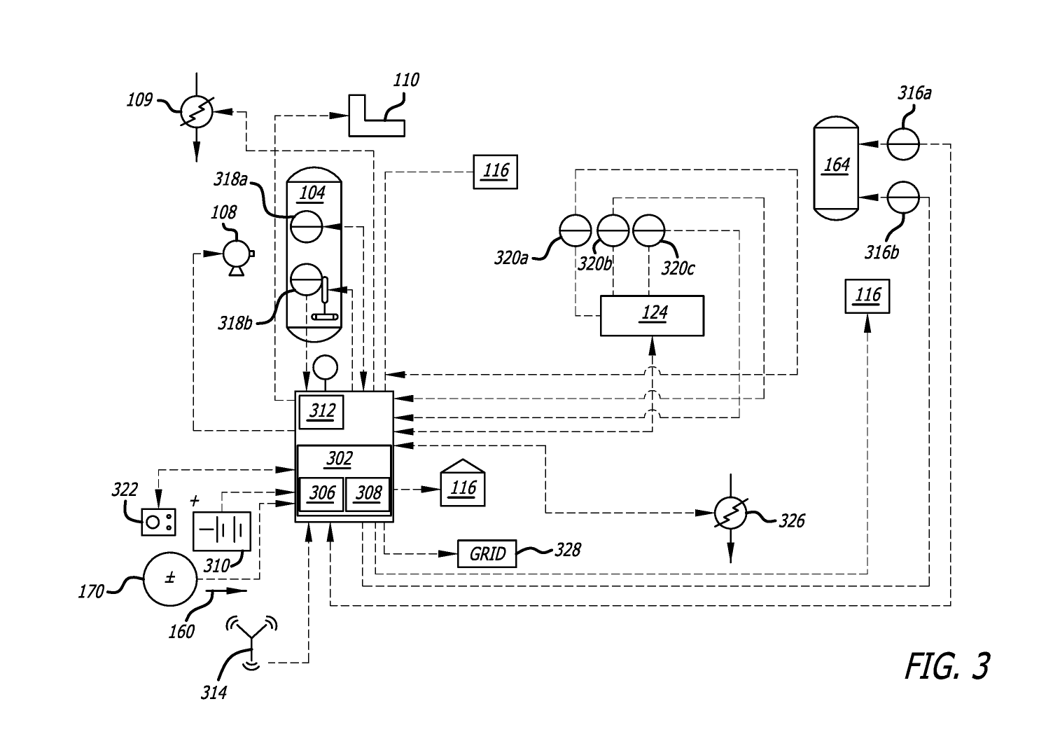

FIG. 3 is a schematic circuit diagram of a control system 300 that may be incorporated into the system 100 of FIG. 1 to operate and regulate the system 100. As illustrated, the control system 300 may include a fuse box or control panel 302 that may be mounted on or otherwise stored in the mobile transport unit 200 of FIG. 2.

In some embodiments, the control panel 302 may include a computer 304 with an associated processor 306 and memory 308. The processor 306 may be configured to execute one or more sequences of instructions, programming stances, or code stored on a non-transitory, computer-readable medium. The processor 306 can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. The memory 308 may comprise the computer-readable medium and may include, for example, random access memory (RAM), flash memory, read only memory (ROM), programmable read only memory (PROM), erasable read only memory (EPROM), a hard disk, a removable disk, a CD-ROM, a DVD, or any other like suitable storage device or medium.

The control panel 302 may be communicably coupled to the electrical power generators 170 (i.e., the hydroelectric generator 158, the wind power generator 172, and the solar power generator 174 each of FIG. 1). Accordingly, the control panel 302 may be configured to receive the electrical power 160 from the electrical power generators 170 and distribute the electrical power 160 to one or more of the electricity-consuming components of the system 100 (FIG. 1). The electrical power generators 170 may be configured to provide direct current (DC) voltage to the control panel 302, while some, if not all, of the electricity-consuming components of the system 100 are configured to consume alternating current (AC). Consequently, the control panel 302 may further include a DC/AC inverter 312 configured to regulate the incoming DC voltage and modulate the DC voltage to AC current for consumption by the electricity-consuming components.

The control panel 302 may also be communicably coupled to a battery 310. In some embodiments, the connection to the battery 310 may be bi-directional such that the control panel 302 is able to receive power from the battery 310 in one mode of operation, and alternatively provide power to the battery 310 in another mode of operation. Accordingly, the battery 310 may be charged (wired or wirelessly) through connection to the control panel 302, but also able to provide power to any of the electricity-consuming components of the system 100 (FIG. 1), as desired.

The control panel 302 may be communicably coupled (wired or wireless) to the electricity-consuming components of the system 100 (FIG. 1) to provide electrical power thereto. As indicated above, the electricity-consuming components of the system 100 can include at least the pump 108, the heater 109, the dehumidifier 110, the submersible pump 116, the UV light sterilizer 124, the water distillation system 136, and the tankless water heater 168. Electrical power originating from either the electrical power generators 170 or the battery 310 may be provided to each of these d electricity-consuming components for operation.

Another electricity-consuming component that may be included in the system 100 (FIG. 1) and communicably coupled (wired or wirelessly) to the control panel 302 includes a communication link 314. The communication link 314 may facilitate wireless bi-directional communication with a user so that a user is able to communicate with and control the system 100 from a remote location. In some embodiments, the communication link may include, for example, an antenna and a router to help facilitate the bi-directional communication.

Other electricity-consuming components that may be included in the system 100 (FIG. 1) and communicably coupled (wired or wirelessly) to the control panel 302 include one or more sensors included in the storage tank 164. As illustrated, for example, the storage tank 164 may include a high-level sensor 316a and a low-level sensor 316b. The high and low level sensors 316a,b may be configured to monitor the fluid level within the storage tank 164 and send an alert signal to the control panel 302 when the fluid level surpasses predetermined high and low levels of operation. In some embodiments, the alert signal may be communicated to the user via the communication link 314 and the user may be able to respond and bring operation of the storage tank 164 back into a predetermined operating range. In other embodiments, however, the computer 304 may be programmed to autonomously change the operational conditions of the storage tank 164 based on the alert signal.

Similarly, the holding tank 104 may also include a high level sensor 318a and a low level sensor 318b, each comprising electricity-consuming components included in the system 100 (FIG. 1) and communicably coupled (wired or wirelessly) to the control panel 302. The high and low level sensors 318a,b may be configured to monitor the fluid level within the holding tank 104 and send an alert signal to the control panel 302 when the fluid level surpasses predetermined high and low levels of operation. Again, such an alert signal may be communicated to the user via the communication link 314 for user consideration. Alternatively, the computer 304 may be programmed to autonomously change the operational conditions of the holding tank 104 based on the alert signal.

Other electricity-consuming components that may be included in the system 100 (FIG. 1) and communicably coupled (wired or wirelessly) to the control panel 302 are various sensors, including a temperature sensor 320a, a flowmeter 320b, and a pressure sensor 320c. The sensors 320a-c are arranged downstream from the UV light sterilizer 124 to monitor the temperature, the flow rate, and the pressure of the water 102 (FIG. 1) or the filtered water 134 (FIG. 1) exiting the filtration system 118 (FIG. 1). Measurements obtained by each sensor 320a-c may be transmitted to the control panel 302 and, in some embodiments, the measurements may be communicated to a user via the communication link 314 for user consideration. Alternatively, the computer 304 may be programmed to detect the measurements and, if needed, autonomously change the operational conditions of the system 100 based on measured parameters.

Other electricity-consuming components that may be included in the system 100 (FIG. 1) and communicably coupled (wired or wirelessly) to the control panel 302 include a camera 322, an alert beacon 324, and a system heater 326. The camera 322 may provide the system 100 with a powered surveillance system and may be programmable and operated by the computer 304. Images captured by the camera 322 may be communicated to a user via the communication link 314 for consideration. As will be appreciated, the camera 322 may also provide the system 100 with form of security.

The alert beacon 324 may comprise at least one of a light and a noise-generating device and may be configured to be activated to alert a user to an abnormal condition of the system 100.

The system heater 326 may be similar in some respects to the heater 109, but may be configured to provide heat for the components of the system 100 or for any other use. Accordingly, the system heater 326 may prove advantageous in maintaining the operating temperature of the components of the system 100 within a desired range.

In some embodiments, the control panel 302 may be configured to provide electrical power directly to the building 162. In such embodiments, the control panel 302 may be able to tie into the power supply of the building 162 and either supplement or replace the power supply for the building 162. In some embodiments, however, and as indicated above, all or a portion of the electrical power 160 generated by the electrical power generators 170 or stored in the battery 310 may be returned back to the local power grid 328.

The system 100 of FIG. 1 may be incorporated into various applications and uses that may benefit local communities. The following includes several example applications, but should not be considered exhaustive.

### Fire Hydrants

In some embodiments, for example, the system 100 (or a variation thereof) may be incorporated into a city or municipal fire hydrant. More specifically, fire hydrants are not utilized the majority of their installed life. Water continues to flow past the hydrants regardless if the hydrant is in use or not. National fire code standards require a fire hydrant to be installed every 500-800 feet in populated areas. In one embodiment, a modified fire hydrant system will use all or part of the components of the system 100 to filter water as it passes by the fire hydrant and simultaneously generate electricity. As will be appreciated, this will improve the quality of the water in the distribution system and reduce operating expenses at water treatment facilities. It will also increase the utilization of hydrants. Furthermore, this may also increase the quality, safety, and performance of the hydrant during a fire due to cleaner water and more stable water pressure. In at least one embodiment, the pump(s) 108 included in the system 100 may be configured to increase the pressure of the water 102 flowing through the hydrants to offset municipal or local system leaks and increase overall water distribution performance. Communication components included in the fire hydrant system may be able to provide detection and operational information back to the municipal or local water treatment facilities.

### Water Towers

In other embodiments, the system 100 (or a variation thereof) may be incorporated into a city or municipal water tower. Water towers are utilized as a storage location, secondary water source, and water distribution system pressure enhancer the majority of their useful life. Water flows into the water tower either continuously or on a periodic basis. The storage capacity and pressure are determined based on the size and height of the water tower. In one embodiment, a modified water tower system will use all or part of the components of the system 100 to filter water as it flows in or out of the water tower and simultaneously generate electricity. As will be appreciated, this will improve the quality of the water in the distribution system and reduce operating expenses at water treatment facilities. It will also increase the utilization of water towers. Flexible solar panels can cover all or a portion of the surface area of a water tower to provide a significant source of power back to the municipality to offset operational and infrastructure costs. Moreover, wireless power distribution can cover a significantly wider area by being placed on top of the water tower. It will increase the quality and performance of the water tower due to the cleaner water, stable water pressure and electricity generation. Furthermore, communication components included in the water tower system may be able to provide detection and operational information back to the municipal or local water treatment facilities. The water tower security components can provide a wide coverage area to help support public safety goals and initiatives.

### Barges

In other embodiments, the system 100 (or a variation thereof) may be incorporated into a barge or other floating vessel. In some embodiments, a barge may contain some of all the components of the system 100 to address the environmental cleanup and remediation of water sources and the generation of electricity. Barges can store the electrical power in onboard batteries or transmit the electrical power wired or wirelessly to shore and back into the distribution system. The barges may operate manually or remotely. In one embodiment, a modified barge system will use all or part of the components of the system 100 to filter water as it passes by or is collected by the barge. This will improve the quality of the local water source and reduce the amount of pollutants and contaminants entering the water treatment facilities. The barges can be permanently docked or moving during system operations. The system communication components will provide detection and operational information back to the municipal or local water treatment facilities.

### Snow Melting Equipment

In other embodiments, the system 100 (or a variation thereof) may be incorporated into snow melting equipment. Snow melting equipment is not utilized the majority of their useful life. The increased frequency and intensity of winter storms and the amount of snow generated presents a large challenge for municipalities. Regulatory requirements also restrict how the amount of snow can be discharged into local waterways. It also a large stress on water treatment facilities which leads into untreated sewage and storm water being dumped into water tributaries and other bodies of water. In one embodiment of a modified snow melting equipment system, all or part of the components of the system 100 may be used to filter water as it leaves the snow melting equipment and generate electricity. This will reduce the amount of water treatment required at the treatment plants and increase the sources of filter and clean and portable water for economic uses. It will also increase the utilization of snow melting equipment. It will also increase the quality, safety, and performance of roads, streets, and sidewalks by reducing the amount of salt or other snow removal agents to maintain municipal road infrastructures. It can also reduce the impact of roads streets and sidewalks experiencing thermal cycles and cracking when exposed to excessive amount of precipitation and colder temperatures. In one embodiment, the melting snow will be converted into hydroelectricity as it is processed and filtered for storage and distribution. The snow melting equipment system communication components will provide detection and operational information back to the municipal or local infrastructure operations and maintenance facilities.

### Electric Vehicle Charging Stations

In other embodiments, the system 100 (or a variation thereof) may be incorporated into electric vehicle charging stations. Electric vehicles are limited based on driving distance and convenient sources of power. A modified electric vehicle charging station can provide a primary or secondary source of clean power to electric vehicles. Power continues to flow past the electric vehicle charging stations regardless if the electric vehicle charging stations is in use or not. One embodiment of the modified electric vehicle charging stations system will use all or part of the components of the system 100 to filter water 102 (e.g., precipitation 106a) and/or generate electricity. The filtered water from the modified electric vehicle charging stations system can be used to help flush municipal water systems or for other portable and not portable water uses. The power can support the system operations or be sent back into the municipal power grid. Power generated by the system is used to charge the electrical vehicles use whether the vehicles public or private. The electric vehicle charging stations communication and safety components will provide detection and operational information back to system users. The electric vehicle charging stations can improve the adoption and usage of clean electric vehicle power and reduce harmful CO₂ and other pollutant emissions into the atmosphere and environment. Some embodiments of the system utilize the power to support multimedia communication platforms at the electric vehicle charging stations. The systems can provide secondary and emergency support to the area if there is a power outage or other local emergencies.

### Bus Stops

In other embodiments, the system 100 (or a variation thereof) may be incorporated into a city or municipal bus stop. Bus stops constitute a convenient outdoor location to collect precipitation 106a and, therefore, are convenient sources of water 102. In one embodiment, a modified bus stop system will use all or part of the components of the system 100 to filter water as it is collected by suitable collection devices 107 included at the bus stop and simultaneously generate electricity. The filtered water from the modified bus stop system can be used to help flush municipal water systems and reduce the amount of scaling and build up of contaminants or pollutants. The discharge of this collected and flushing water can be used to generate hydroelectricity and sent back into the municipal power grid. In some embodiments, power generated by the modified bus stop system may be used to charge the electrical vehicles use by the municipality or items requiring power by users. In one embodiment, the modified bus stop system will provide heat and power to the bus stop to increase the safety, quality, and utility for users. The bus stop communication and safety components will provide detection and operational information back to public works and other municipal departments or facilities. The bus stop system can improve the station utilization, safety, quality, and efficiency of municipal or local transportation systems. Some embodiments of the modified bus stop system utilize the power to support multimedia communication platforms at the bus stop. The systems can provide secondary and emergency support to areas if there is a power outage or other local emergencies.

### Rest Stations

In other embodiments, the system 100 (or a variation thereof) may be incorporated into a city or state rest station. Rest stations are often located at points along highways that have limited or difficult locations to provide sustained quality water and power. In one embodiment, a modified rest stop system will use all or part of the components of the system 100 to filter water as it is collected by suitable collection devices 107 included at the rest stop and simultaneously generate electricity. The filtered water from the modified rest stop station system can be used to support the operations and maintenance of the rest stop facility. In some embodiments, power generated by the rest stop station system may be used to charge the electrical vehicles or items requiring power by users. The rest stations communication and safety components will provide detection and operational information back to public works and other municipal departments or facilities. The rest stop station system can improve the utilization, safety, quality, and efficiency of highway transportation systems. Some embodiments of the rest stop station system utilize the power to support multimedia communication platforms at the rest stations. The rest stop station systems can provide secondary and emergency support to areas if there is a power outage or other emergencies.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A portable water collection, filtration and power generation system, comprising:
a holding tank configured to receive water from a water source, the water source comprising at least one of precipitation and a municipal water source; and
a filtration system fluidly coupled to the holding tank, the filtration system including an input configured to receive water from the holding tank, a filter disposed in fluid communication with the input, and an output to configured to discharge filtered water from the filtration system;
a reverse osmosis system fluidly coupled to the filtration system, the reverse osmosis system including an input configured to receive filtered water from the filtration system and an output configured to discharge reverse osmosis water;
at least one electrical power generator electrically coupled to at least one of the filtration system and the reverse osmosis system, wherein the at least one electrical power generator is configured to transmit electrical power; and
a mobile transport unit, wherein the holding tank, the filtration system, the reverse osmosis system, and the at least one electrical power generator are each disposed within the mobile transport unit.

2. The system of claim 1, wherein the source of water further includes at least one of groundwater and dehumidifier water.

3. The system of claim 2, further comprising a pump to convey at least one of the precipitation, the groundwater, and the dehumidifier water to the holding tank.

4. The system of claim 1, further comprising a heater used to warm the precipitation.

5. The system of claim 1, further comprising a submersible pump positioned in the holding tank to pump the water to the filtration system.

6. The system of claim 1, wherein the filtration system comprises a filter and an ultraviolet (UV) light sterilizer.

7. The system of claim 6, wherein the filtration system further comprises a bypass fluid circuit that diverts the water around the filters and the UV light sterilizer.

8. The system of claim 1, further comprising a water distillation system that receives at least a first portion of the filtered water and produces distilled water.

9. The system of claim 8, wherein the water distillation system includes a point of consumption for a user to access the reverse osmosis water.

10. The system of claim 1, wherein the reverse osmosis system further produces wastewater and at least a portion of the wastewater is conveyed to the holding tank.

11. The system of claim 10, wherein the at least one electrical power generators comprises a hydro-electric generator that receives at least one of the wastewater, filtered water and reverse osmosis water and converts fluid pressure of the at least one of the wastewater, filtered water and reverse osmosis water into electrical power.

12. The system of claim 1, wherein the reverse osmosis system includes a point of consumption for a user to access the distilled water.

13. The system of claim 1, wherein at least a portion of the filtered water is provided to a structure comprising a storage tank that receives the at least another portion of the filtered water; and a point of consumption fluidly coupled to the storage tank for a user to access the at least another portion of the filtered water from the storage tank.

14. The system of claim 13, wherein the structure further comprises a tankless water heater that receives the at least a first portion of the filtered water, and a point of consumption fluidly coupled to the tankless water heater for a user to access the at least another portion of the filtered water from the tankless water heater.

15. The system of claim 1, wherein the one or more electrical power generators are selected from the group consisting of a hydro-electric generator, a wind power generator, a solar power generator, and a nanogenerator.

16. The system of claim 15, wherein the nanogenerator is a piezoelectric generator.

17. The system of claim 1, wherein the at least one electrical power generator provides electrical power sufficient to power at least one either the filtration system and the reverse osmosis system.

18. The system of claim 1, wherein at least a portion of the electrical power produced by the at least one electrical power generator is transmitted to a local power grid.

19. The system of claim 1, further comprising an energy storage device, the energy storage device being coupled to at least one electrical power generator.

20. The system of claim 18, wherein the energy storage device is selected from the group consisting of a capacitor and a battery.
